(19) United States
(12) Patent Application Publication
(10) Pub. No.: US 2007/0257838 A1
(43) Pub. Date: Nov. 8, 2007

(54) Method of compressing GPS assistance data to reduce the time for calculating a location of a mobile device

(75) Inventor: Ming Cheng, East Brunswick, NJ (US)

Correspondence Address: MICHAELSON & ASSOCIATES, P.O. BOX 8489, RED BANK, NJ, 07701, US

(73) Assignee: Spirent Communications, Inc.

(21) Appl. No.: 11/605,093

(22) Filed: Nov. 28, 2006

Related U.S. Application Data
(60) Provisional application No. 60/753,249, filed on Dec. 22, 2005.

(51) Int. Cl. G01S 5/14

(52) U.S. Cl. 342/357.15; 342/357.09

(57) ABSTRACT

The invention relates to global positioning system (GPS) assistance data, and in particular, an embodiment in which a method of compressing GPS assistance data reduces the time to transmit data and also reduce time to calculate a location for a mobile device, such as a wireless telecommunications device. The method is especially-well suited for satellites have similar Almanac and/or Navigation Model information elements. The time for a Serving Mobile Location Centre (SMLC) to transmit the compressed assistance data to the mobile device is thus reduced. This eventually reduces the total time for a mobile device to calculate its location based on the assistance data information. Hence the time to first fix (TTFF) which is the time to calculate the first “fix” (also known as the first calculated location) is reduced.

### CLAIM TO PRIORITY

This application claims the benefit of our co-pending United States provisional patent application entitled “METHOD OF COMPRESSING GPS ASSISTANCE DATA TO REDUCE THE TIME FOR CALCULATING A LOCATION OF A MOBILE DEVICE” filed Dec. 22, 2005 and assigned Ser. No. 60/753,249, which is incorporated by reference herein.

### BACKGROUND OF THE DISCLOSURE

1. Field of the Invention

The invention relates to global positioning system (GPS) assistance data, and in particular to a method of compressing GPS assistance data to reduce time to transmit data and also reduce time to calculate a location for a mobile device such as a wireless telecommunications device.

2. Description of the Prior Art

### BACKGROUND

Information Sources

In describing the prior art, reference is made herein to information available on the World Wide Web, as well as in various documents. Citations to the various sources are made in the description. For convenience, the following is a list of most sources cited herein:
911 Services at www.fcc.gov/911/last updated Nov. 24, 2004.
Wireless 911 Services at www.fcc.gov/cgb/consumerfacts/wireless911srvc.html last updated Sep. 23, 2005.
Enhanced 911—Wireless Services, www.fcc.gov/911/enhanced/last updated Jun. 17, 2005; and Wireless 911 Services, www.fcc.gov/cgb/consumerfacts/wireless911srvc.html last updated Sep. 23, 2005.
Unraveling the GPS Mystery, Ohio University On-line Factsheet, AEX-560-99, ohioline.osu.edu/aex-fact/0560.html, by Timothy S. Stombaugh Assistant Professor, Brian R. Clement Graduate Associate, herein incorporated by reference.
Navigation Satellites at http://collections.ic.gc.ca/satellites/english/engineer/copy/navigati/index.html.
Types of Satellites at www.encyclopedia.com/html/section/satelart_Typesof Satellites.asp by Columbia Encyclopedia 2005.
3GPP TS04.31: “Location Service (LCS); Mobile Station (MS)—Serving Mobile Location Centre (SMLC) Radio Resource LCS Protocol (RRLP).”**
3GPP TS03.71: “Location Services (LCS); (Functional description)—Stage 2.”**
Global Positioning System Standard Positioning Service Signal Specification—Jun. 2, 1995**
Ephemeris at www.meriamwebster.com/
FACCH in Companion Links at http://www.mpirical.com/companion/mpirical_companion.html#http://www.mpirical.com/companion/GSM/FACCHChannel.htm ©2005 by mpirical limited
M Software Ltd of New Zealand, at www.msoftware.co.nz/WinRK_downloads.php
www.winzip.com/
www.7-zip.org/
A homemade receiver for GPS & GLONASS satellites at http://lea.hamradio.si/˜s53mv/navsats/theory.html by Matjaz Vidmar.
Navigation Satellites, Types and Uses of Satellites by Galactics at http://collections.ic.gc.ca/satellites/english/engineer/copy/navigati/index.html at Canada's Digital Collections, Last updated on Aug. 8, 1997.
Types of Satellites at www.encyclopedia.com/html/section/satelart_Typesof Satellites.asp by High Beam Research Inc. © 2005.
Guidelines for Testing and Verifying the Accuracy of E911 Location Systems, OET BULLETIN No. 71, Apr. 12, 2000. **
http://en.wikipedia.org/wiki/Trilateration, page was last modified 16:16, 18 Nov. 2005, subject to GNU Free Documentation Lisence.
GPS Basics, at www.tycoelectronics.com/gps/basics.asp, titled by Tyco Electronics, dated 20 Dec. 2005.

Whereby, sources marked with double asterisks “**” are hereby incorporated by reference.

Glossary of Acronyms & Terms

In description of the present invention, and related technology areas, various acronyms and other terms are used. For ease of reference, many acronyms and terms are defined in this Glossary.

Acronyms

| | |
|---|---|
| AGPS | Assisted GPS |
| ALI | Automatic Location Identification |
| BSC | Base Station Centre |
| CDMA | Code Division Multiple Access |
| DOD | Department of Defence |
| E-OTD | Enhanced Observed Time Difference |
| FACCH | Fast Associated Control Channel |
| FCC | Federal Communications Commission |
| GPS | Global Positioning System |
| GPRS | General Packet Radio Service |
| GSM | Global System for Mobile Communications |
| LBS | Location Based Services |
| LCS | LoCation Services |
| LS | Location Services |
| MO | Mobile Originated |
| MO-LR | Mobile Originated Location Request |
| MS | Mobile Station |
| MT-LR | Mobile Terminated Location Request |
| PCS | Personal Communications Service |
| PCF | Position Calculation Function |
| PSAP | Public Safety Answering Point |
| RRLP | Radio Resource LCS Protocol |
| SMLC | Serving Mobile Location Center |
| SMR | Specialized Mobile Radio |
| SV | Space Vehicle |
| TTFF | Time To First Fix |
| ULTS | UMTS Location Test System |
| UMTS | Universal Mobile Terrestrial System |
| W-CDMA | Wideband CDMA |

Terms

The following Glossary of Terms is incorporated from the Guidelines for Testing and Verifying the Accuracy of E911 Location Systems, OET BULLETIN No. 71, Apr. 12, 2000:
Automatic Location Identification (ALI)—Delivery of the location of a wireless handset to a PSAP without the need for inquiry by the dispatcher
Differential GPS (DGPS)—A method for correcting inaccuracies in GPS location calculations by use of signals from a terrestrial reference station.
Enhanced 911 (E911)—An emergency telephone system using the digits 9-1-1 that provides additional information to the emergency dispatcher, such as Automatic Number Identification and Automatic Location Identification.
Global Positioning System (GPS)—A network of 24 U.S. government satellites, supported by ground control systems, transmitting radio signals that can be decoded to compute precise locations.
Handset-based Location Technology—A method of providing the location of wireless 911 callers that requires the use of special location-determining hardware and/or software in a portable or mobile phone. Handset-based location technology may also employ additional location-determining hardware and/or software in the wireless network and/or another fixed infrastructure.
Network-based Location technology—A method of providing the location of wireless 911 callers that employs hardware and/or software in the wireless network and/or another fixed infrastructure, and does not require the use of special location determining hardware and/or software in the caller's portable or mobile phone.
Public Safety Answering Point (PSAP)—A 911 answering station designated to receive 911 calls from a specific geographic area.
Phase I E911—The first step in implementing wireless E911. Under Phase I, as of Apr. 1, 1998, licensees subject to the E911 rules must provide the telephone number of the originator of the 911 call and the location of the cell site or base station receiving the call from any mobile handset accessing their systems to the designated PSAP. This requirement applies only if certain conditions are met: that the PSAP has requested the service and is capable of receiving and utilizing the data, and that a mechanism for recovery of the PSAP's costs is in place.
Phase II E911—The second step in implementing wireless E911. Under Phase II, as of Oct. 1, 2001, licensees subject to the E911 rules must provide to the PSAP the location of all 911 calls by longitude and latitude in conformance with specified accuracy requirements, subject to the same conditions that apply to Phase I. Wireless carriers are required to report their plans for implementing Phase II, including the technology they plan to use to provide caller location, by Oct. 1, 2000.

Additional terms, from GPS Basics, dated 20 Dec. 2005, at http://www.tycoelectronics.com/gps/basics.asp, follow:
Cold start—The GPS receiver has a valid almanac stored. The Almanac data is valid for at least a year and most receivers store this data in battery backed RAM or non-volatile memory. TTFF is determined largely by the time taken to download a full ephemeris packet. This is determined by the satellite data rate of 50 bps and takes around 45 seconds depending on where in the message the system is at switch-on.
Autonomous start—The GPS unit has no information of time, ephemeris or Almanac data. This normally only occurs when the unit is first powered.
Warm start—The GPS receiver has valid ephemeris and almanac data but not accurate time. This can vary from 7-15 seconds on the quality (age, up to four hours) of the ephemeris data stored.
Hot start—The GPS receiver has valid ephemeris, almanac and time
Obscuration—If a satellite being tracked and used in a navigation solution by a GPS unit is momentarily hidden from the GPS antenna then Obscuration recovery is the TTFF after the satellite reappears in line of sight. This is particularly relevant in a mobile receiver in an urban canyon situation where passing a tall building may temporarily obscure a satellite from the antenna.

911 Services

The official national emergency number in the United States is 911. Dialing 911 quickly connects a caller to a Public Safety Answering Point (PSAP) dispatcher trained to route the call to local emergency medical, fire, and law enforcement agencies. The 911 network is a vital part of the United States' emergency response and disaster preparedness system. (See, 911 Services at www.fcc.gov/911/last updated Nov. 24, 2004).

In the United States, most 911 systems presently automatically report the telephone number and location of 911 calls made from wireline phones, a capability called Enhanced 911 or E911. (See, 911 Services, www.fcc.gov/911/last updated Nov. 24, 2004). Upgrades in the 911 network to provide emergency help more quickly and effectively are made practically constantly. (See, 911 Services at www.fcc.gov/911/last updated Nov. 24, 2004). Upgrades include improvements to the 911 system used in wireless telecommunications, including the requirement of E911 capability for wireless telecommunications. In the late 1990s, the United States FCC (Federal Communications Commission) promulgated administrative rules requiring wireless telephone carriers to provide E911 capability. (See, 911 Services, www.fcc.gov/911/last updated Nov. 24, 2004).

Improvements to the E911 system for wireless communications significantly impact the safety of citizens due to the sheer numbers of wireless communications device users. In the United States, the number of 911 calls placed by people using wireless phones has more than doubled since 1995, to over 50 million calls per year. Public safety personnel estimate that about 30% of the millions of 911 calls received daily are placed from wireless phones, and that percentage is growing. (See, Wireless 911 Services at www.fcc.gov/cgb/consumerfacts/wireless911srvc.html last updated Sep. 23, 2005).

While wireless phones are an important public safety tool, they also create unique challenges for public safety and emergency response personnel and for wireless service providers. This is due largely to the mobile nature of a wireless phone and its user. For example, a wireless phone is actually a radio with a transmitter and a receiver that uses radio frequencies or channels—instead of telephone wire—to connect callers. Because wireless phones are by their very nature mobile, they are not associated with one fixed location or address. A caller using a wireless phone could be calling from anywhere. While the location of a particular cell tower used to carry a 911 call may provide a very general indication of the location of the caller, that information is not usually specific enough (or obtained quickly enough) for rescue personnel to deliver assistance to the caller quickly, or in a timely manor. (See, Wireless 911 Services at www.fcc.gov/cgb/consumerfacts/wireless911srvc.html last updated Sep. 23, 2005). Therefore, any solution that can increase the timeliness of locating the caller is welcome.

Enhanced 911—Wireless Services

The FCC's Basic 911 rules require wireless carriers to transmit all 911 calls to a Public Safety Answering Point, regardless of whether the caller subscribes to the carrier's service or not. (See, Wireless 911 Services at www.fcc.gov/cgb/consumerfacts/wireless911srvc.html last updated Sep. 23, 2005). The wireless E911 program is divided into two parts—Phase I and Phase II.

Phase I requires wireless carriers to deliver to the emergency dispatcher the telephone number of a wireless handset originating a 911 call, as well as the location of the cell site or base station receiving the 911 call, which provides a rough indication of the caller's location. Phase II requires carriers to deliver more specific latitude and longitude location information, known as Automatic Location Identification (ALI), to the dispatcher. (See, FCC NRW titled FCC Adjusts Its Rules To Facilitate The Development Of Nationwide Enhanced Wireless 911 Systems of Sep. 8, 2000 reporting and FCC Action by the Commission by Order on Reconsideration, Docket No. FCC 00-326 dated Aug. 24, 2000).

The Wireless 911 rules are being implemented in stages; they are not all immediately effective. The FCC, recognizing the complexities inherent in the deployment of cutting edge technologies that enable wireless E911 not only implemented the order in two phases but also allows for parties such as wireless carriers to request guidance and relief from the rules in order to implement Phase II. Implementation is heavily dependent upon availability of appropriate, cost effective technology. Hence, wireless carriers and equipment manufacturers need an opportunity to develop, implement and improve equipment to facilitate wireless E911. This includes improvements in time to calculate “first fix”.

The Federal Communications Commission has made several adjustments to its wireless enhanced 911 (E911) rules to facilitate full compliance with those rules on a nationwide basis, including certain modifications to the deployment schedule that must be followed by wireless carriers choosing to implement the Commission's E911 Phase II requirements using a handset-based technology . . . . In addition, the Commission addressed several petitions by companies seeking waivers in this proceeding. The Commission's actions establish a more practical, understandable, and workable schedule for implementation of handset-based technologies. The adopted rules also provide additional clarity about the Commission's wireless E911 Phase II rules to wireless carriers, equipment manufacturers, and the public safety community, as well as to others involved in the development and deployment of location technologies.” (See, FCC NRW titled FCC Adjusts Its Rules To Facilitate The Development Of Nationwide Enhanced Wireless 911 Systems of Sep. 8, 2000 reporting and FCC Action by the Commission by Order on Reconsideration, Docket No. FCC 00-326 dated Aug. 24, 2000).

Phase I requires wireless carriers, within six months of a request by a local Public Safety Answering Point, to provide the PSAP with the telephone number of the originator of a wireless 911 call and the location of the cell site or base station transmitting the call.

Phase II require wireless carriers, within six months of a request by a Public Safety Answering Point, to provide the PSAP with the telephone number of the originator of a wireless 911 call and the location, specifically, the latitude and longitude of the caller of the cell site or base station transmitting the call. This information must meet FCC accuracy standards; generally, it must be accurate to within 50-300 meters (depending on the type of technology used). (See, Enhanced 911—Wireless Services, www.fcc.gov/911/enhanced/last updated Jun. 17, 2005; and See, Wireless 911 Services, www.fcc.gov/cgb/consumerfacts/wireless911srvc.html last updated Sep. 23, 2005).

Location information must be delivered to PSAPs within a reasonable time to permit its effective use by emergency response teams. This presents at least two separate issues. First, location information should be available as soon as possible, with little or no delay in normal call delivery, to assist in routing the call to the correct PSAP and to provide rapid location information to the dispatcher. Second, location information is needed by emergency response teams responding to the call, who will benefit from more accurate location information. To accommodate both of these objectives, available location information should be delivered with call completion, but verification of the accuracy of the information may take place shortly after call completion. Any test protocol should identify the time to first fix (including fixes from Phase I or other location methods), which will be used to route calls to the proper PSAP, and should also employ a reasonable time limit for tests of location accuracy. An acceptable time limit for such testing is 30 seconds after the call is sent. Multiple attempts to determine location may be made within that period and the latest location data based upon these attempts within the period may be used in calculating accuracy. In evaluating compliance, recommendations by the National Emergency Number Association and standards committees regarding time limits for location accuracy measurement should be considered.

When fully implemented, wireless E911 will provide the precise location of 911 calls from wireless phones. The wireless E911 program is an important part of the FCC's programs to apply modern communications technology to public safety. (See, 911 Services, www.fcc.gov/911/last updated Nov. 24, 2004). Of course, the availability of equipment to support that is able to support the E911 program is imperative to the program's success. And, continuing technological advances in equipment is important

GPS System and Location Calculation

The GPS system was designed by and is controlled by the United States Department of Defense (DOD) and can be used by anyone, free of charge. The GPS system is divided into three segments: space, control and user. The space segment comprises the GPS satellite constellation. The control segment comprises ground stations around the world that are responsible for monitoring the flight paths of the GPS satellites, synchronizing the satellites' onboard atomic clocks, and uploading data for transmission by the satellites. The user segment consists of GPS receivers used for both military and civilian applications. A GPS receiver decodes time signal transmissions from multiple satellites and calculates its position by trilateration. (See, http://en.wikipedia.org/wiki/GPS,

E911 Automatic Location Identification

Mobile phones with embedded GPS (Global Positioning System) capability are becoming increasingly popular and are expected to be even more popular in the future. The development of these mobile phones with embedded GPS is fuelled, in part, by the U.S. Federal Communications Commission E911 mandate for wireless services, described above.

In addition to other efforts to promote coordinated emergency services, the FCC has adopted wireless 911 rules. These rules are aimed at improving the reliability of wireless 911 services and identifying the location of wireless 911 callers to enable emergency response personnel to provide assistance to them much more quickly. The location identification is also used by law enforcement entities to, for example, help track and capture criminals. The FCC's wireless 911 rules apply to all cellular licensees, broadband Personal Communications Service (PCS) licensees, and certain Specialized Mobile Radio (SMR) licensees. (Wireless 911 Services at www.fcc.gov/cgb/consumerfacts/wireless911srvc.html last updated Sep. 23, 2005). Hence the equipment used for wireless communications by these services needs to be configured to quickly facilitate location.

For many Americans, the ability to call 911 for help in an emergency is one of the main reasons for owning a wireless phone. Other wireless 911 calls come from Good Samaritans reporting traffic accidents, crimes or other emergencies. Prompt delivery of these and other wireless 911 calls to public safety organizations benefits the public by promoting safety of life and property. (See, Wireless 911 Services at www.fcc.gov/cgb/consumerfacts/wireless911srvc.html last updated Sep. 23, 2005).

In addition to using a wireless telephone to make emergency telephone calls, other services are offered or planned for wireless telephone users, for which, the location or position of the wireless phone is dependent. These services, called Location-Based Services, are emerging as a new opportunity for network operators to generate new revenues. Services such as driving directions, identifying closest movie theaters or restaurants, and tracking of people for safety or in emergency situations are being deployed currently by wireless network operators.

Location-Based Services (LBS) rely on some method of computing the user's location. Of the various methods, the Assisted GPS (AGPS) method is the most accurate. The AGPS method refers to any of several variants that make use of GPS signals or additional signals derived from GPS signals in order to calculate MS (Mobile Station), i.e. wireless phone, position.

An AGPS mobile uses satellites in space as reference points to determine location. By accurately measuring the distance from satellites, the mobile receiver triangulates its position anywhere on earth. The mobile receiver measures distance by measuring the time required for the signal to travel from the satellite to the receiver. This requires precise time information.

Triangulation is further described, with respect to a GPS system, as follows: “GPS receivers use a principle called triangulation. Triangulation is a method of determining the position of an object by measuring its distance from other objects with known locations. A GPS receiver uses the signals from a satellite to determine its distance from that satellite . . . if you know your distance from one satellite, you could be anywhere on a sphere around that satellite. If you add distance information from a second satellite, you narrow your location to the intersection of the two spheres around those satellites, which puts you somewhere on a circle. Addition of a third sphere locates you at one of two points. Though one of the points can usually be eliminated as an unreasonable location, a fourth satellite signal will give confidence in which point is valid. Though [typically] only four satellite signals are required to get a valid position, some receivers are equipped to receive as many as 12 satellite signals simultaneously. The extra satellites are used to increase accuracy.” (See, Unraveling the GPS Mystery, Ohio University On-line Factsheet, AEX-560-99, http://ohioline.osu.edu/aex-fact/0560.html, by Timothy S. Stombaugh Assistant Professor, Brian R. Clement Graduate Associate, herein incorporated by reference).

Accurate time can be derived from the satellite signals, but this requires demodulating data from the GPS satellites at a relatively slow rate (i.e., 50-bits per second) and requires that the satellite signals be relatively strong.

Thus, a need exists in the art for a method of quickly calculating location of a mobile device.

### SUMMARY OF THE INVENTION

To address this limitation, an AGPS capable mobile device utilizes aiding data from an SMLC (Serving Mobile Location Center) that provides the mobile information it would normally have to demodulate, as well as other information which increases start-up sensitivity and reduces start times. The AGPS approach eliminates the long start times typical of conventional GPS, and allows the AGPS mobile device to operate in difficult GPS signal environments, including indoors.

A method compresses GPS assistance data. The method is specifically suited for satellites have similar Almanac and/or Navigation Model information elements. The time for a Serving Mobile Location Centre (SMLC) to transmit the compressed assistance data to the mobile device is thus reduced. This eventually reduces the total time for a mobile device to calculate its location based on the assistance data information.

Thus, a need exists in the art for the present invention with which a method more quickly calculates location of a mobile device.

This invention overcomes the disadvantages of the prior art by providing a method for using GPS assistance data to reduce the total time for a mobile device to calculate its location based on the assistance data information.

The method is specifically suited for satellites have similar Almanac and/or Navigation Model information elements. The time for an SMLC (Serving Mobile Location Centre) to transmit the compressed assistance data to the mobile device is thus reduced.

This eventually reduces the total time for a mobile device to calculate its location based on the assistance data information.

The foregoing is accomplished by compressing GPS assistance data as described Infra.

### BRIEF DESCRIPTION OF THE DRAWINGS

The teachings of the present invention can be readily understood by considering the following detailed description in conjunction with the accompanying drawings, in which:

FIG. 1 shows a block diagram illustrating a Assisted GPS (AGPS) system with which an embodiment of the present invention may be implemented;

FIG. 2 is a geometric representation illustrating a point, point B, for which location is determined by calculation, and three reference points P1, P2 and P3 which are used to calculate the location of point B.

FIG. 3a illustrates the steps of the Position Measurement procedure. FIG. 3b illustrates the steps of the Assistance Data Delivery Procedure.

FIG. 4 illustrates the steps of obtaining compressed data from one base station with SMLC.

To facilitate understanding, identical reference numerals have been used, where possible, to designate identical elements that are common to the figures.

### DETAILED DESCRIPTION

After considering the following description, those skilled in the art will clearly realize that the teachings of my invention can be readily utilized in

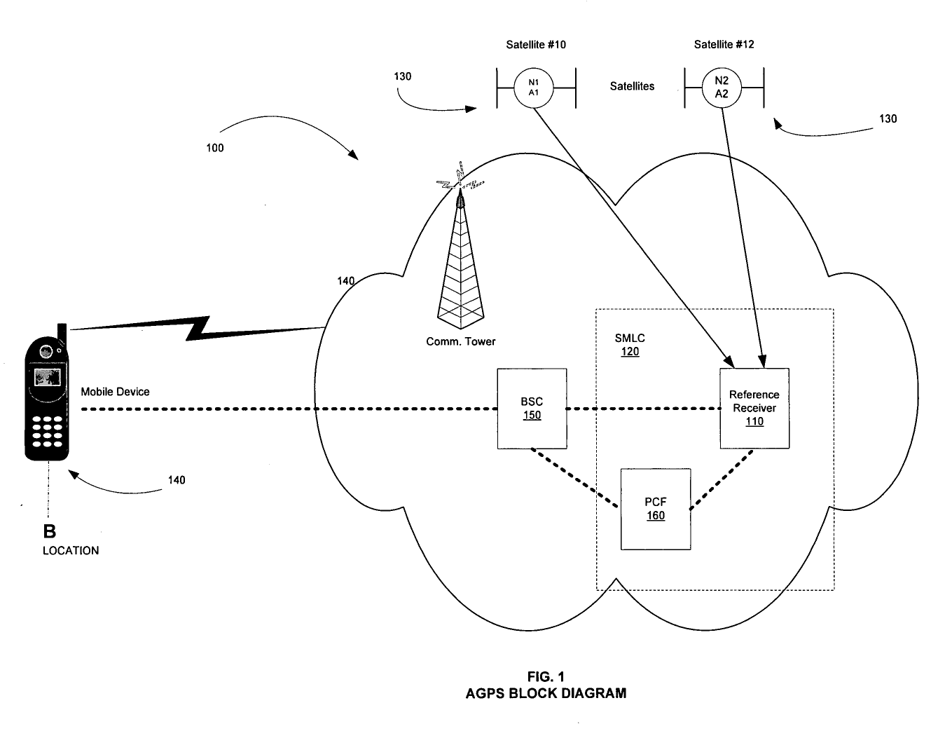

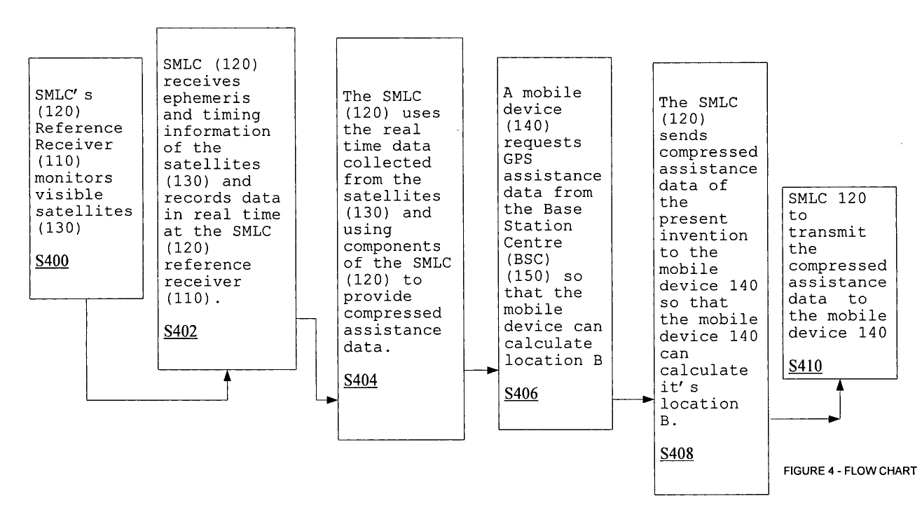

FIG. 1 shows a block diagram illustrating an Assisted GPS (AGPS) system 100 with which an embodiment of the present invention may be implemented. Furthermore, FIG. 1 illustrates the principles of AGPS operation. The Reference Receiver 110 inside the SMLC (Serving Mobile Location Centre) 120 continually monitors visible satellites 130 in the sky. The ephemeris¹ and timing information of the satellites 130 are recorded in the SMLC in real time. When a mobile device 140, shown for illustration purposes as a mobile phone, tries to calculate its location, the mobile device 140 will send a request to the Base Station Centre (BSC) 150 asking for GPS assistance data. The BSC 150 will pass the request to the SMLC 150 which will send responses back to the mobile device 140 with recorded assistance data of the applicable satellites 130. The SMLC 120 comprises Reference Receiver 110 and PCF (Position Calculation Function) 160. An embodiment of the present invention may be implemented to calculate location B of mobile device 140; this is further illustrated with respect to FIG. 4.
¹ Ephemeris, as defined by the Merriam-Webster Online Dictionary is “a tabular statement of the assigned places of a celestial body for regular intervals.” (See, ephemeris at www.meriamwebster.com/).

With the AGPS approach, the size of the assistance data (not shown) can be large. The typical entire assistance data of one satellite is about 100 bytes in a GSM (Global System for Mobile Communications) network. This is large and is further illustrated by example below.

For example, in an AGPS approach, it would take about 800 ms to transmit on a common signaling channel, such as for example, FACCH² (Fast Associated Control Channel). Assume there are total 9 satellites visible, that means it would take about 7 seconds (800 ms×9 satellites=7200 ms or 7.2 seconds) for the SMLC to transmit all assistance data to the mobile device 140. In a timing critical environment like Enhanced 911, also known as E911, this is a significant timing overhead. Thus, a method to compress the assistance data to reduce the transmission time is important to the improved performance of the E911 system. One method is to compress the assistance data using compression tools available for purchase on the market such as WinRK³, WINZIP®⁴ or 7-Zip⁵.
² FACCH—The Fast Associated Control Channel appears in place of the traffic channel when lengthy signaling is required between a GSM mobile and the network while the mobile is in call. The channel is indicated by use of the stealing flags in the normal burst. Typical signaling where this may be employed is during cell handover. (See, FACCH in Companion Links at http://www.mpirical.com/companion/mpirical_companion.html#http://www.mpirical.com/companion/GSM/FACCHChannel.htm ©2005 by mpirical limited).

³ WinRK is a high performance, multi-format file archiver. It supports many command archive formats, including ZIP, RAR, ACE, BZIP2, TAR, RK and ISO. The new WinRK format combines industry leading compression, encryption and analysis with almost unlimited archive size. The modern interface provides a new intuitive way to manage archives, including full integration with the Windows Shell. Wink is commercially available for download from M Software Ltd of New Zealand, at www.msoftware.co.nz/WinRK_downloads.php.

⁴ WinZip® is a commercially available data compression program created by WinZip Computing of Mansfield, Conn., USA and at www.winzip.com/.

⁵ 7-Zip is a file archiver with high compression ratio and is free software distributed under the GNU Lesser General Public License. 7-Zip Supported formats are: Packing/unpacking: 7z, ZIP, GZIP, BZIP2 and TAR; Unpacking only: RAR, CAB, ARJ, LZH, CHM, Z, CPIO, RPM and DEB. 7-Zip was created by Igor Pavlov and is available for download at www.7-zip.org/.

Experiments were performed using the above noted compression tools; however, the results were not satisfactory. Due to the highly randomized nature of the assistance data, the compressed ratio varied from different sample data sets. Emphical data was gathered and although the best ratio was as high as 35 percent, the average ratio was only about 10 percent. In some experiments, the size of the compressed data set was even larger than the original size which is an unacceptable result. Thus, finding a method that utilizes assistance data characteristics and yield a higher compress ratio is crucial, and not necessarily as simple as just compressing the data. Such a method, is the method of the present invention, and is described below.

A method of the present invention compresses AGPS data and is specifically suited for satellites 130 having similar Almanac data⁶ and/or Navigation⁷ Model information elements. The exemplary Almanac data (A1, A2) satellites 130 of FIG. 1, have data represented in Tables A, B and C below. The exemplary Navigational Model (N1, N2) satellites 130 of FIG. 1, have data represented in Tables D, E and F below. The time for an SMLC 120 to transmit the compressed assistance data to the mobile device 140 is thus reduced; hence the total time for a mobile device 140 to calculate its location based on the assistance data information is in turn reduced.
⁶ Almanac is not a type of satellite, per se, but rather a type of data obtained from a satellite. For each satellite, an on-board computer generates the so-called navigation data. These include information about the exact location of the satellite, also called precision ephemeris, information about the offset and drift of the on-board atomic clock and information about other satellites in the system, also called almanac. The first two are used directly by the user's-computer to assemble the navigation equations. The almanac data can be used to predict visible satellites and avoid attempting to use dead, malfunctioning or inexistent satellites, thus speeding-up the acquisition of valid satellite. (See, A homemade receiver for GPS & GLONASS satellites at http://lea.hamradio.si/˜s53mv/navsats/theory.html by Matjaz Vidmar).

⁷Navigational satellites are explained as follows: “Today, most navigation systems use time and distance to determine location. Early on, scientists recognized the principle that, given the velocity and the time required for a radio signal to be transmitted between two points, the distance between the two points can be computed. The calculation must be done precisely, and the clocks in the satellite and in the ground-based receiver must be telling exactly the same time—they must be synchronized. If they are, the time it takes for a signal to travel can be measured and then multiplied by the exact speed of light to obtain the distance between the two positions.” (See, Navigation Satellites, Types and Uses of Satellites by Galactics at http://collections.ic.gc.ca/satellites/english/engineer/copy/navigati/index.html at Canada's Digital Collections, Last updated on Aug. 8, 1997). And further explained by another source: “Navigation satellites were developed primarily to satisfy the need for a navigation system that nuclear submarines could use to update their inertial navigation system. This led the U.S. navy to establish the Transit program in 1958; the system was declared operational in 1962 after the launch of Transit 5A. Transit satellites provided a constant signal by which aircraft and ships could determine their positions with great accuracy. In 1967 civilians were able to enjoy the benefits of Transit technology. However, the Transit system had an inherent limitation. The combination of the small number of Transit satellites and their polar orbits meant there were some areas of the globe that were not continuously covered—as a result, the users had to wait until a satellite was properly positioned before they could obtain navigational information. The limitations of the Transit system spurred the next advance in satellite navigation: the availability of 24-hour worldwide positioning information. The Navigation Satellite for Time and Ranging/Global Positioning Satellite System (Navstar/GPS) consists of 24 satellites approximately 11,000 miles above the surface of the earth in six different orbital planes. The GPS has several advantages over the Transit system: It provides greater accuracy in a shorter time; users can obtain information 24 hours a day; and users are always in view of at least five satellites, which yields highly accurate location information (a direct readout of position accurate to within a few yards) including altitude. In addition, because of technological improvements, the GPS system has user equipment that is smaller and less complex. The former Soviet Union established a Navstar equivalent system known as the Global Orbiting Navigation Satellite System (GLONASS). GLONASS uses the same number of satellites and orbits similar to those of Navstar. Many of the handheld GPS receivers can also use the GLONASS data if equipped with the proper processing software.” (See, Types of Satellites at www.encyclopedia.com/html/section/satelart_TypesofSatellites.asp by High Beam Research Inc. © 2005).

The GPS assistance (AGPS) data is divided into nine (9) information elements:

1) Reference Time

2) Reference Location

3) DGPS Corrections

4) Navigation Model

5) Ionospheric Model

6) UTC Model

7) Almanac

8) Acquisition Assistance

9) Real Time Integrity

Amongst these information elements, the Navigation Model and the Almanac data together comprise about 90% of the total assistance data size.

The set of Almanac data fields (Tables A, B and C) specify the coarse, long-term model of the satellite positions and clocks for all satellites in the GPS constellation.

The set of Navigation Model fields (Tables D, E and F) contains information of precise GPS navigation data for visible satellites.

TABLE A
Satellite Almanac A1 Values (Satellite ID #10)

| | Bit | |
|---|---|---|
| Field Symbol & Field Name | Size | Value(A1) |
| E1(A1) SatelliteID | 6 | 10 |
| E2(A1) AlmanacE | 16 | 2164 |
| E3(A1) AlmanacToa | 8 | 4 |
| E4(A1) AlmanacKsii | 16 | 35681 |
| E5(A1) AlmanacOmegaDot | 16 | 32049 |
| E6(A1) AlmanacSVHealth | 8 | 0 |
| E7(A1) AlmanacAPowerHalf | 24 | 10554690 |
| E8(A1) AlmanacOmega0 | 24 | 8175960 |
| E9(A1) AlmanacW | 24 | 1596384 |
| E10(A1) AlmanacM0 | 24 | 15742658 |
| E11(A1) AlmanacAF0 | 11 | 1028 |
| E12(A1) AlmanacAF1 | 11 | 1024 |
| E1(A1) + . . . + E12(A1) | 188 | N/A |

TABLE B
Satellite Almanac A2 Values (Satellite ID #12)

| | Bit | |
|---|---|---|
| Field Symbol & Field Name | Size | Value(A2) |
| E1(A2) SatelliteID | 6 | 12 |
| E2(A2) AlmanacE | 16 | 4071 |
| E3(A2) AlmanacToa | 8 | 4 |
| E4(A2) AlmanacKsii | 16 | 35681 |
| E5(A2) AlmanacOmegaDot | 16 | 32083 |
| E6(A2) AlmanacSVHealth | 8 | 0 |
| E7(A2) AlmanacAPowerHalf | 24 | 10554722 |
| E8(A2) AlmanacOmega0 | 24 | 13905403 |
| E9(A2) AlmanacW | 24 | 8556967 |
| E10(A2) AlmanacM0 | 24 | 1129227 |
| E11(A2) AlmanacAF0 | 11 | 1020 |
| E12(A2) AlmanacAF1 | 11 | 1024 |
| E1(A2) + . . . + E12(A2) | 188 | N/A |

TABLE C
Satellite Almanac Delta A1-A2 Values (Satellite ID #10-#12)

| | Bit | Value Delta |
|---|---|---|
| Field Symbol & Field Name | Size | (A2 − A1) |
| E1(A1-A2) SatelliteID | 6 | N/A |
| E2(A1-A2) Delta_AlmanacE | 11 | 1907 |
| E3(A1-A2) Delta_AlmanacToa | 1 | 0 |
| E4(A1-A2) Delta_AlmanacKsii | 1 | 0 |
| E5(A1-A2) Delta_AlmanacOmegaDot | 6 | 34 |
| E6(A1-A2) Delta_AlmanacSVHealth | 1 | 0 |
| E7(A1-A2) Delta_AlmanacAPowerHalf | 5 | 32 |
| E8(A1-A2) Delta_AlmanacOmega0 | 23 | 5429083 |
| E9(A1-A2) Delta_AlmanacW | 23 | 6960583 |
| E10(A1-A2) Delta_AlmanacM0 | 24 | −14613431 |
| E11(A1-A2) Delta_AlmanacAF0 | 4 | −8 |
| E12(A1-A2) Delta_AlmanacAF1 | 1 | 0 |
| E1(A1-A2) + . . . + E12(A1-A2) | 106 | N/A |

Although the values of the fields in Navigation Model and Almanac data vary from satellite to satellite, the deltas (Δ) of the values of many of these fields between each satellite are very small compared to their original values as can be seen from the data of Tables A through F. Thus, much fewer bits are needed to encode the delta value (i.e. Δ(A1, A2)=A1−A2 or Δ(N1, N2)=N1−N2) than to encode the original values i.e. A1, A2, N1 or N2. For example, it takes 24-bit to encode the AlmanacAPowerHalf in Table A and 24-bit to encode the AlmanacAPowerHalf in Table B, but it only requires 5-bit to encode the Delta_AlmanacAPowerHalf (in Table C).

TABLE D
Satellite Navigation Model N1 Values (Satellite ID #20)

| | Bit | |
|---|---|---|
| Field Symbol & Field Name | Size | Value(N1) |
| E1(N1) SatelliteID | 6 | 20 |
| E2(N1) SatStatus extension | 1 | 0 |
| E3(N1) satStatus | 2 | 0 |
| E4(N1) ephemCodeOnL2 | 2 | 1 |
| E5(N1) ephemURA | 4 | 0 |
| E6(N1) ephemSVhealth | 6 | 0 |
| E7(N1) ephemIODC | 10 | 0 |
| E8(N1) ephemL2Pflag | 1 | 0 |
| E9(N1) EphemerisSubframe1Reserved1 | 23 | 0 |
| E10(N1) EphemerisSubframe1Reserved2 | 24 | 0 |
| E11(N1) EphemerisSubframe1Reserved3 | 24 | 0 |
| E12(N1) EphemerisSubframe1Reserved4 | 16 | 0 |
| E13(N1) ephemTgd | 8 | 128 |
| E14(N1) ephemToc | 16 | 20250 |
| E15(N1) ephemAF2 | 8 | 128 |
| E16(N1) ephemAF1 | 16 | 32768 |
| E17(N1) ephemAF0 | 22 | 2097152 |
| E18(N1) ephemCrs | 16 | 30442 |
| E19(N1) ephemDeltaN | 16 | 44834 |
| E20(N1) ephemM0 | 32 | 490292430 |
| E21(N1) ephemCuc | 16 | 30668 |
| E22(N1) ephemE | 32 | 149803008 |
| E23(N1) ephemCus | 16 | 33587 |
| E24(N1) ephemAPowerHalf | 32 | 2701986560 |
| E25(N1) ephemToe | 15 | 20250 |
| E26(N1) ephemFitFlag | 1 | 0 |
| E27(N1) ephemAODA | 5 | 0 |
| E28(N1) ephemCic | 16 | 32862 |
| E29(N1) ephemOmegaA0 | 32 | 2933022765 |
| E30(N1) ephemCis | 16 | 32689 |
| E31(N1) ephemI0 | 32 | 2816046937 |
| E32(N1) ephemCrc | 16 | 44236 |
| E33(N1) ephemW | 32 | 490512128 |
| E34(N1) ephemOmegaADot | 24 | 8365888 |
| E35(N1) ephemIDot | 14 | 8438 |
| E1(N1) + . . . + E35(N1) | 552 | N/A |

TABLE E
Satellite Navigation Model N2 Values (Satellite ID #22)

| | Bit | |
|---|---|---|
| Field Symbol & Field Name | Size | Value(N2) |
| E1(N2) SatelliteID | 6 | 22 |
| E2(N2) SatStatus extension | 1 | 0 |
| E3(N2) satStatus | 2 | 0 |
| E4(N2) ephemCodeOnL2 | 2 | 1 |
| E5(N2) ephemURA | 4 | 0 |
| E6(N2) ephemSVhealth | 6 | 0 |
| E7(N2) ephemIODC | 10 | 0 |
| E8(N2) ephemL2Pflag | 1 | 0 |
| E9(N2) EphemerisSubframe1Reserved1 | 23 | 0 |
| E10(N2) EphemerisSubframe1Reserved2 | 24 | 0 |
| E11(N2) EphemerisSubframe1Reserved3 | 24 | 0 |
| E12(N2) EphemerisSubframe1Reserved4 | 16 | 0 |
| E13(N2) ephemTgd | 8 | 128 |
| E14(N2) ephemToc | 16 | 20250 |
| E15(N2) ephemAF2 | 8 | 128 |
| E16(N2) ephemAF1 | 16 | 32768 |
| E17(N2) ephemAF0 | 22 | 2136064 |
| E18(N2) ephemCrs | 16 | 30417 |
| E19(N1) ephemDeltaN | 16 | 32768 |
| E20(N1) ephemM0 | 32 | 707779220 |
| E21(N1) ephemCuc | 16 | 39857 |
| E22(N1) ephemE | 32 | 132792320 |
| E23(N1) ephemCus | 16 | 33691 |
| E24(N1) ephemAPowerHalf | 32 | 2701831424 |
| E25(N1) ephemToe | 15 | 20250 |
| E26(N1) ephemFitFlag | 1 | 0 |
| E27(N1) ephemAODA | 5 | 0 |
| E28(N1) ephemCic | 16 | 32868 |
| E29(N1) ephemOmegaA0 | 32 | 2961954125 |
| E30(N1) ephemCis | 16 | 32772 |
| E31(N1) ephemI0 | 32 | 2803659195 |
| E32(N1) ephemCrc | 16 | 44016 |
| E33(N1) ephemW | 32 | 901932800 |
| E34(N1) ephemOmegaADot | 24 | 8366208 |
| E35(N1) ephemIDot | 14 | 8192 |
| E1(N2) + . . . + E35(N2) | 552 | N/A |

TABLE F
Satellite Navigation Model Delta (N1-N2) (Satellite ID #20-#22)

| | | Value |
|---|---|---|
| | Bit | Delta |
| Field Symbol & Field Name | Size | (N2 − N1) |
| E1(N1-N2) SatelliteID | 6 | N/A |
| E2(N1-N2) Delta_SatStatus extension | 1 | 0 |
| E3(N1-N2) Delta_satStatus | 1 | 0 |
| E4(N1-N2) Delta_ephemCodeOnL2 | 1 | 0 |
| E5(N1-N2) Delta_ephemURA | 1 | 0 |
| E6(N1-N2) Delta_ephemSVhealth | 1 | 0 |
| E7(N1-N2) Delta_ephemIODC | 1 | 0 |
| E8(N1-N2) Delta_ephemL2Pflag | 1 | 0 |
| E9(N1-N2) Delta_EphemerisSubframe1Reserved1 | 1 | 0 |
| E10(N1-N2) Delta_EphemerisSubframe1Reserved2 | 1 | 0 |
| E11(N1-N2) Delta_EphemerisSubframe1Reserved3 | 1 | 0 |
| E12(N1-N2) Delta_EphemerisSubframe1Reserved4 | 1 | 0 |
| E13(N1-N2) Delta_ephemTgd | 1 | 0 |
| E14(N1-N2) Delta_ephemToc | 1 | 0 |
| E15(N1-N2) Delta_ephemAF2 | 1 | 0 |
| E16(N1-N2) Delta_ephemAF1 | 1 | 0 |
| E17(N1-N2) Delta_ephemAF0 | 16 | 38912 |
| E18(N1-N2) Delta_ephemCrs | 6 | −25 |
| E19(N1-N2) Delta_ephemDeltaN | 15 | −12066 |
| E20(N1-N2) Delta_ephemM0 | 28 | 217486790 |
| E21(N1-N2) Delta_ephemCuc | 14 | 9189 |
| E22(N1-N2) Delta_ephemE | 26 | −17010688 |
| E23(N1-N2) Delta_ephemCus | 7 | 104 |
| E24(N1-N2) Delta_ephemAPowerHalf | 19 | −15136 |
| E25(N1-N2) Delta_ephemToe | 1 | 0 |
| E26(N1-N2) Delta_ephemFitFlag | 1 | 0 |
| E27(N1-N2) Delta_ephemAODA | 1 | 0 |
| E28(N1-N2) Delta_ephemCic | 4 | 8 |
| E29(N1-N2) Delta_ephemOmegaA0 | 27 | 28931360 |
| E30(N1-N2) Delta_ephemCis | 7 | 83 |
| E31(N1-N2) Delta_ephemI0 | 25 | −12387742 |
| E32(N1-N2) Delta_ephemCrc | 9 | −220 |
| E33(N1-N2) Delta_ephemW | 32 | 411420672 |
| E34(N1-N2) Delta_ephemOmegaADot | 9 | 320 |
| E35(N1-N2) Delta_ephemIDot | 9 | −246 |
| E1(N1-N2) + . . . + E35(N1-N2) | 277 | N/A |

Hence, the concept of the present invention is to transmit the original values for a first satellite (i.e. A1 or A2), then delta for a second satellite (i.e. N1, N2) which the values of many of its fields are close to the first satellite, only transmit the delta values (i.e. A1-A2, or N1-N2) (each delta value being the differences between an information element value for the first satellite and an information element value for the second satellite). Since the delta value requires much fewer bits, the overall data size is reduced. This concept is further illustrated in the example below.

For example, as can be illustrated using data from Tables A through F:
i. Referring to Table A and Table B, it takes 376 bits to transmit Almanac element for satellites A1 and A2 (also referred to as satellites #10 and #12, respectively). The total bits are calculated by adding the sum of elements E1(A1)+ . . . +E12(A1) from Table A and the sum of elements E1(A2)+ . . . E12(A2) from Table B (hence 188+188=376).
ii. Referring to Table A and Table C, it takes fewer total bits to transmit Almanac element for Satellites A1 and A2, as compared to data used from Table A and Table B (in example (i) above). This is illustrated by showing a total of 294 bits to transmit Almanac element for satellites A1 and A2 (also known as satellites #10 and #12) in Table A and Table C. The total bits are calculated by adding the sum of elements E1(A1)+ . . . +E12(A1) from Table A and the sum of elements E1(A1-A2)+ . . . +E12(A1-A2) from Table C (hence 188+106=294).
iii. Hence, the above example of the present invention illustrates that the number of bit is reduced if the present invention delta values are used the Bit Size is needed for the compression method of the present invention. The Bit Size at E1(A1)+ . . . +E12(A1) from Table A tells that total of 188-bit is needed to encode all the Almanac information for satellite 10. Similarly, The Bit Size at E1(A2)+ . . . +E12(A2) from Table B tells that total of 188-bit is needed to encode all the Almanac information for satellite 12. And the Bit Size at E1(A1-A2)+ . . . +E12(A1-A2) from Table C tells that total of 106-bit is needed to encode all the delta information.
iv. Referring to Table D and Table E, it takes 1104 bits to transmit Navigation Model element for satellites N1 and N2 (also known as satellites #20 and #22). The total bits are calculated by adding the sum of elements E1 E1(N1)+ . . . +E36(N1) from Table D and the sum of elements E1(N2)+ . . . +E36(N2) from Table E (hence 552+552=1104).
v. Referring to Table D and Table F, it takes fewer total bits to transmit Navigation Model element for Satellites N1 and N2, as compared to data used from Table D and Table E (in example (iii) above). This is illustrated by showing a total of 810 bits to transmit Navigation Model element for satellites N1 and N2 (also known as satellites #20 and #22) in Table D and Table F. The total bits are calculated by adding the sum of elements E1(N1)+ . . . +E12(N1) from Table D and the sum of elements E1(N1-N2)+ . . . +E12 (N1-N2) from Table F (hence 533+277=810).
vi. One of ordinary skill in the art would understand that the data presented herein, such as in Tables A-F, are for illustration purposes and that the compression method would work with other data, and is not meant to be confined only to the data presented herein.

The data illustrates a compressed ratio of approximately 25%. The compression ratio is calculated as follows:
The bits for Table A and Table B as compared to Table A and Table C are reduced 21.8% which is calculated as followed using data from (i) and (ii) above:
   (1−294/376)×100=21.8%.
The bits for Table D and Table E as compared to Table D and Table F are reduced 26.6% which is calculated as followed using data from (iii) and (iv) above:
   (1−810/1104)×100=26.6%

The compression ratio can be even greater if the method of the present invention is applied using more than two satellites. One of ordinary skill in the art could apply the compression ration using more than two satellites.

The method compresses GPS assistance data. The method is specifically suited for satellites have similar Almanac and/or Navigation Model information elements. The time for a Serving Mobile Location Centre (SMLC) to transmit the compressed assistance data to the mobile device is thus reduced. This eventually reduces the total time for a mobile device to calculate its location based on the assistance data information.

Of course, by reducing the time for a mobile device to calculate its location, the time for the device to first calculate its location is improved. This is known to those skilled in the art as the “Time to First Fix” (TTFF)⁸. Hence, the compressed GPS assistance data of the present invention improves the Time To First Fix, and of course, time to subsequent fixes.
⁸ The following TTFF information is directly from the webpage: http://www.tycoelectronics.com/gps/basics.asp, titled GPS Basics, dated 20 Dec. 2005: An important measure of performance is defined as the Time To First Fix (TTFF). This is defined for the following conditions: Cold start—The GPS receiver has a valid almanac stored. The Almanac data is valid for at least a year and most receivers store this data in battery backed RAM or non-volatile memory. TTFF is determined largely by the time taken to download a full ephemeris packet. This is determined by the satellite data rate of 50 bps and takes around 45 seconds depending on where in the message the system is at switch-on. Autonomous start—The GPS unit has no information of time, ephemeris or Almanac data. This normally only occurs when the unit is first powered since the GPS can store this data in either battery backed memory or in non-volatile memory. The time is determined statistically based on the state of the satellite messages when the receiver is turned on and the time that it takes the satellites to transmit a complete set of data. The number and strength of the visible satellites will also affect it. In an open area with a good antenna that is well placed this time is about 90 seconds. This can be reduced by feeding the receiver with an approximate position (within 100 Km) and the time of day Warm start—The GPS receiver has valid ephemeris and almanac data but not accurate time. This can vary from 7-15 seconds on the quality (age, up to four hours) of the ephemeris data stored. Hot start—The GPS receiver has valid ephemeris, almanac and time Obscuration—If a satellite being tracked and used in a navigation solution by a GPS unit is momentarily hidden from the GPS antenna then Obscuration recovery is the TTFF after the satellite reappears in line of sight. This is particularly relevant in a mobile receiver in an urban canyon situation where passing a tall building may temporarily obscure a satellite from the antenna.

The compressed data available using the method of the present invention can be used in various calculations, by one of ordinary skill in the art, to determine the location of a mobile device. Calculations can be performed in a number of ways. Some calculations are dictated by specifications produced by industry organizations (i.e. 3^{rd} Generation Partnership Project (3GPP)). Two specifications by 3GPP are 1) 3GPP TS03.71 V8.7.0 (2002-09), Technical Specification Group Services and System Aspects, Location Services (LCS), (Functional description)—Stage 2 (Release 1999) and 2) 3GPP TS04.31 V8.10.0 (2002-07), Technical Specification Group GSM/EDGE Radio Access Network; Location Services (LCS), Mobile Station (MS)—Serving Mobile Location Centre (SMLC) Radio Resource LCS Protocol (RRLP), (Release 1999). The appropriate specification, as well as other calculation methods, can be determined by one of ordinary skill in the art.

For example, 3GPP TS03.71 V8.7.0 (2002-09) is directed to Location Services (LCS), Functional description—Stage 2. The scope of this specification is to define “the stage-2 service description for the LoCation Services (LCS) feature on GSM, which provides the mechanisms to support mobile location services of operators, which are not covered by standardized GSM services. CCITT I.130 . . . describes a three-stage method for characterization of telecommunication services, and CCITT Q.65 . . . defines stage 2 of the method. The LCS feature is a network feature and not a supplementary service. This version of the stage 2 service description covers aspects of LCS e.g., the functional model, architecture, positioning methods, message flows etc.” (See, 3GPP TS03.71 V8.7.0 (2002-09), Technical Specification Group Services and System Aspects, Location Services (LCS), (Functional description)—Stage 2 (Release 1999), Scope at page 9 of 108 (references omitted)).

“LCS utilizes one or more positioning mechanisms in order to determine the location of a Mobile Station. Positioning a target MS involves two main steps: signal measurements and location estimate computation based on the measured signals. Three positioning mechanisms are proposed for LCS: Uplink Time of Arrival (TOA), Enhanced Observed Time Difference (E-OTD), and Global Positioning System (GPS) assisted.” (See, 3GPP TS03.71 V8.7.0 (2002-09), Technical Specification Group Services and System Aspects, Location Services (LCS), (Functional description)—Stage 2 (Release 1999), Main Concepts at page 12 of 108).

Another example uses specification 3GPP TS04.31 V8.10.0 (2002-07). The scope of this specification is to define “Radio Resource LCS Protocol (RRLP) to be used between the Mobile Station (MS) and the Serving Mobile Location Centre (SMLC) . . . the functionality of the protocol . . . the message structure, and . . . the structure of components . . . . [The specification also] contains the ASN.1 description of the components.” (See, 3GPP TS04.31 V8.10.0 (2002-07), Technical Specification Group GSM/EDGE Radio Access Network; Location Services (LCS), Mobile Station (MS)—Serving Mobile Location Centre (SMLC) Radio Resource LCS Protocol (RRLP), (Release 1999), Scope at page 6 of 59).

The 3GPP TS04.31 V8.10.0 (2002-07) specification defines one generic RRLP message that is used to transfer Location Services (LCS) related information between the Mobile Station (MS) and the Serving Mobile Location Centre (SMLC). Usage of the RRLP protocol on a general level is described in the reference . . . that includes Stage 2 description of LCS. One message includes one of the following components: [1)] Measure Position Request; [2)] Measure Position Response; [3)] Assistance Data; [4)] Assistance Data Acknowledgement; [5)] Protocol Error. Next subchapters describe the usage of these components. (See, 3GPP TS04.31 V8.10.0 (2002-07), Technical Specification Group GSM/EDGE Radio Access Network; Location Services (LCS), Mobile Station (MS)—Serving Mobile Location Centre (SMLC) Radio Resource LCS Protocol (RRLP), (Release 1999), General at pages 5-6 of 59).

The 3GPP TS04.31 V8.10.0 (2002-07) specification further states that ÷[d]elivery of components may be supported in the RRLP level by sending several shorter messages instead of one long message. This may be used to avoid lower level segmentation of messages and/or to improve the reliability of assistance data delivery to the MS in the event that delivery is interrupted by an RR management event like handover. Any assistance data that is successfully delivered to an MS and acknowledged prior to interruption of positioning by an event like handover shall be retained by the MS and need not be resent by the SMLC when positioning is again reattempted. The lower layers take care of segmentation if the RRLP message is larger than the maximum message size at the lower layers.” (See, 3GPP TS04.31 V8.10.0 (2002-07), Technical Specification Group GSM/EDGE Radio Access Network; Location Services (LCS), Mobile Station (MS)—Serving Mobile Location Centre (SMLC) Radio Resource LCS Protocol (RRLP), (Release 1999), General at page 6 of 59).

Trilateration is a method of determining the relative positions of objects using the geometry of triangles in a similar fashion as triangulation. Unlike triangulation, which uses angles measurements (together with at least one known distance) to calculate the subject's location, trilateration uses the known locations of two or more reference points, and the measured distance between the subject and each reference point. To accurately and uniquely determine the relative location of a point on a 2D plane using trilateration alone, generally at least 3 reference points are needed.

Hyperbolic positioning systems use a variant of trilateration: what is being measured is the difference in distance from the subject to . . . synchronized reference stations . . . . The GPS satellite positioning system is based on hyperbolic positioning, but in three dimensions: four satellites (orbital “reference stations”) are commonly sufficient for obtaining a fix (a calculated location). The unknowns solved for are, besides the positioned receiver's three coordinates, its clock offset . . . thus one can use the GPS system also for precise time dissemination . . . http://en.wikipedia.org/wiki/Trilateration

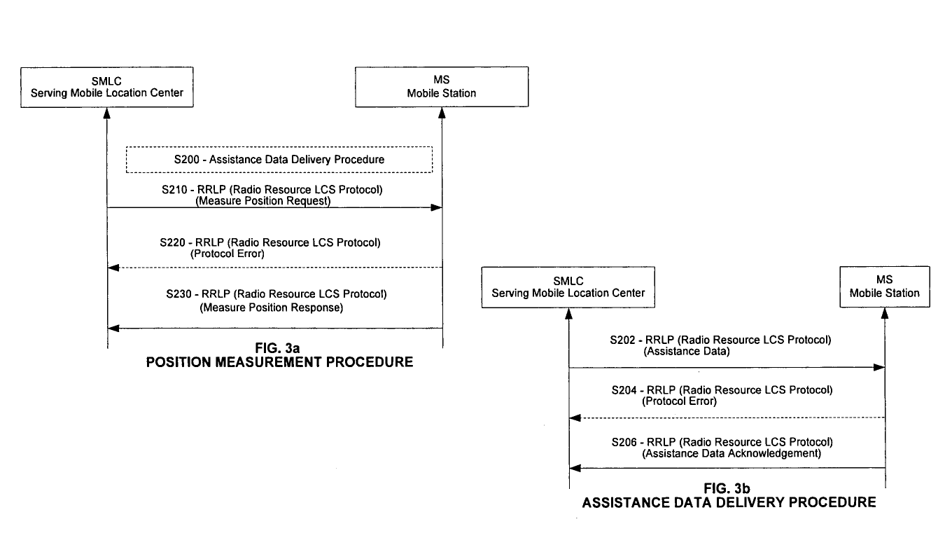

For example,⁹ a mathematical derivation for the solution of a three-dimensional trilateration problem can be found by taking the formulae for three spheres, illustrated in FIG. 2, and setting them equal to each other. To do this, three constraints we must applied to the centers of these spheres; all three must be on the z=0 plane, one must be on the origin, and one other must be on the x-axis. It is, however, possible to transform any set of three points to comply with these constraints, find the solution point, and then reverse the transformation to find the solution point in the original coordinate system.
⁹ The entire trilateration example, description and accompanying figure are taken from: http://en.wikipedia.org/wiki/Trilateration

Regarding FIG. 2, it should be read as follows: It is desired to determine the location of B relative to the reference points P1, P2, and P3. Measuring r1 narrows B's position down to a circle. Next, measuring r2 narrows B's position down to two points, A and B. A third measurement, r3, gives B's coordinates. A fourth measurement could also be made to reduce error in B's calculated location.¹⁰
¹⁰ The description of the FIG. 2 is taken from: http://en.wikipedia.org/wiki/Trilateration at the description of the Figure in a frame at the given URL.

The relationship of FIG. 2 to the mobile location calculation herein, is that the mobile receiver for which a location is being calculated is at point B, whereas reference points P1, P2 and P3 are satellites in GPS constellation.

Starting with three spheres,
r₁²=x²+y²+z²,
r₂²=(x−d)²+y²+²,
and
r₃²=(x−i)²+(y−j)²+z²,

next, subtract the second from the first and solve for x:

$$x = \frac{{r}_{1}^{2} - {r}_{2}^{2} + {d}^{2}}{2 d} .$$

Substituting this back into the formula for the first sphere produces the formula for a circle, the solution to the intersection of the first two spheres:

$${y}^{2} + {z}^{2} = {r}_{1}^{2} - \frac{{( {r}_{1}^{2} - {r}_{2}^{2} + {d}^{2} )}^{2}}{4 {d}^{2}} .$$

Setting this formula equal to the formula for the third sphere finds:

$$y = \frac{{r}_{1}^{2} - {r}_{3}^{2} + {( x - i )}^{2}}{2 j} + \frac{j}{2} - \frac{{( {r}_{1}^{2} - {r}_{2}^{2} + {d}^{2} )}^{2}}{8 {d}^{2} j}$$

Now that the x- and y-coordinates of the solution point are obtained, the formula for the first sphere can simply be rearranged to find the z-coordinate:
z=\sqrt{r₁²−x²−y²}

The solutions to all three points x, y and z have now been obtained. Because z is expressed as a square root, it is possible for there to be zero, one or two solutions to the problem.

This last part can be visualized as taking the circle found from intersecting the first and second sphere and intersecting that with the third sphere. If that circle falls entirely outside of the sphere, z is equal to the square root of a negative number: no real solution exists. If that circle touches the sphere on exactly one point, z is equal to zero. If that circle touches the surface of the sphere at two points, then z is equal to plus or minus the square root of a positive number.

In the case of no solution, a not uncommon one when using noisy data, the nearest solution is zero. One should be careful, though, to do a sanity check and assume zero only when the error is appropriately small.

In the case of two solutions, some technique must be used to disambiguate between the two. This can be done mathematically, by using a fourth sphere and determining which point lies closest to its surface. Or it can be done logically—for example, GPS systems assume that the point that lies inside the orbit of the satellites is the correct one when faced with this ambiguity, because it is generally safe to assume that the user is never in space, outside the satellites' orbits.

One of ordinary skill in the art would know how to use the Trilateration of the above description, or triangulation (not illustrated), if desired, to determine the location (i.e. location B) of a mobile receiver, such as a mobile receiver implementing the method of the present invention.

One of ordinary skill in the art would know how to use the Trilateration of the above description, or triangulation (not illustrated), if desired, to determine the location (i.e. location B) of an emulated mobile receiver, such as a an emulated mobile receiver implementing the method of the present invention.

An AGPS mobile uses satellites in space as reference points to determine location. By accurately measuring the distance from satellites, the mobile receiver triangulates its position anywhere on earth. The mobile measures distance by measuring the time required for the signal to travel from the satellite to the receiver. This requires precise time information. Accurate time can be derived from the satellite signals, but this requires demodulating data from the GPS satellites at a relatively slow rate (50-bit per second) and requires that the satellite signals be relatively strong. To address this limitation, an AGPS capable mobile utilizes aiding data from an SMLC that provides the mobile information it would normally have to demodulate as well as other information which increases start-up sensitivity and reduces start times. The AGPS approach eliminates the long start times typical of conventional GPS and allows the AGPS mobile to operate in difficult GPS signal environments, including indoors.

Returning now to FIG. 1, which illustrates the principles of AGPS operation, the Reference Receiver inside the SMLC keeps monitoring all visible satellites in the sky. The ephemeris and timing information of the satellites are recorded in the SMLC in real time. When the mobile device tries to calculate its location, it will send a request to the Base Station Centre (BSC) asking for GPS assistance data. The BSC will pass the request to the SMLC, which will send responses back to the mobile with recorded assistance data of the applicable satellites.

Accurate time can be derived from the satellite signals, but this requires demodulating data from the GPS satellites at a relatively slow rate (i.e., 50-bits per second) and requires that the satellite signals be relatively strong. To address this limitation, an AGPS capable mobile device utilizes aiding data from an SMLC (Serving Mobile Location Center) that provides the mobile information it would normally have to demodulate, as well as other information which increases start-up sensitivity and reduces start times. The AGPS approach eliminates the long start times typical of conventional GPS and allows the AGPS mobile device to operate in difficult GPS signal environments, including indoors.

A method compresses GPS assistance data. The method is specifically suited for satellites have similar Almanac and/or Navigation Model information elements. The time for a Serving Mobile Location Centre (SMLC) to transmit the compressed assistance data to the mobile device is thus reduced. This eventually reduces the total time for a mobile device to calculate its location based on the assistance data information.

Position Measurement Procedure. This Position Measurement Procedure is the same that is described on a more general level in the 3GPP technical specification 3GPP TS03.71: “Location Services (LCS); (Functional description)—Stage 2” in the chapter “E-OTD and GPS Positioning Procedures” in subchapters “Positioning for BSS based SMLC” and “Positioning for NSS based SMLC”. The purpose of this Position Measurement procedure is to enable the SMLC (Serving Mobile Location Centre) to request for position measurement data or location estimate from the MS (Mobile Station), and the MS to respond to the request with measurements or location estimate.

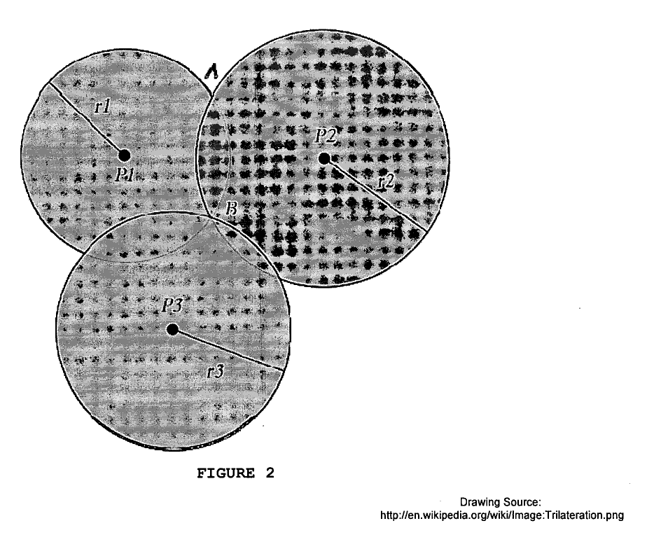

FIG. 3a illustrates the steps of the Position Measurement procedure. The position measurement steps are illustrated for informational purposes. While these steps do not incorporate the compressed data of the present invention, one of ordinary skill in the art could use the compressed data of the present invention to perform similar position measurement steps, making modifications where appropriate. The Measure Position Request component may be preceded by an Assistance Data Delivery Procedure (further illustrated in FIG. 3a) to deliver some or all of the entire set of assistance data that is needed by the subsequent positioning procedure. The steps of FIG. 3a include Step S200 Assistance Data Delivery Procedure (see FIG. 3b, steps S202, S204, S206) to deliver some or all of the entire set of assistance data that is needed by the subsequent positioning procedure (steps S210, S220, S230). Next, at step S210 the Measure Position Request component, the SMLC (Serving Mobile Location Center) sends the Measure Position Request component in a RRLP (Radio Resource LCS Protocol wherein LCS is LoCation Services) message to the MS. The component includes QoS, other instructions, and possible assistance data to the MS. The RRLP message contains a reference number of the request.

Regarding step S220, the MS sends a RRLP message containing the Protocol Error component to the SMLC, if there is a problem that prevents the MS to receive a complete and understandable Measure Position Request component. The RRLP message contains the reference number included in the Measure Position Request received incomplete. The Protocol Error component includes a more specific reason. When the SMLC receives the Protocol Error component, it may try to resend the Measure Position Request (go back to the step S210), abort location, or send a new measure Position Request (e.g. with updated assistance data).

Next, at step S230, the MS tries to perform the requested location measurements, and possibly calculates it own position. When the MS has location measurements, location estimate, or an error indication (measurements/location estimation not possible), it sends the results in the Measure Position Response component to the SMLC. The RRLP message contains a reference number of the request originally received in the step S210. If there is a problem that prevents the SMLC to receive a complete and understandable Measure Position Response component, the SMLC may decide to abort location, or send a new Measure Position Request component instead.

Assistance Data Delivery Procedure. This procedure is the same that is described on a more general level in the 3GPP technical specification 3GPP TS03.71: “Location Services (LCS); (Functional description)—Stage 2” in the chapter “E-OTD and GPS Positioning Procedures” in subchapters “Assistance Data Delivery from BSS based SMLC” and “Assistance Data Delivery from NSS based SMLC”. The purpose of this Assistance Data Delivery Procedure is to enable the SMLC to send assistance data to the MS related to position measurement and/or location calculation. Notice that RRLP protocol is not used by the MS to request assistance data, only to deliver it to the MS. The entire set of assistance data (i.e. the total amount of assistance data that the SMLC has decided to send in the current procedure) may be delivered in one or several Assistance Data components. In this case steps S202 and S206 of FIG. 3b may be repeated several times by the SMLC. If several components are sent, the SMLC awaits the acknowledgement of each component before the next Assistance Data component is sent.

FIG. 3b illustrates the steps of the Assistance Data Delivery Procedure, S202, S204, S206. At Step S202, the SMLC sends the Assistance Data component to the MS. The component includes assistance data for location measurement and/or location calculation. The RRLP message contains a reference number (not shown) of the delivery. At step S204, the MS sends a RRLP message containing the Protocol Error component to the SMLC, if there is a problem that prevents the MS to receive a complete and understandable Assistance Data component. The RRLP message contains the reference number (not shown) included in the Assistance Data component received incomplete. The Protocol Error component includes a more specific reason. When the SMLC receives the Protocol Error component, it may try to resend the Assistance Data component (go back to the step S202), send a new measure Assistance Data set (e.g. with updated assistance data), or abort the delivery.

Next, at step S206, when the MS has receives the complete Assistance Data component, it sends the Assistance Data Acknowledgement component to the SMLC. The RRLP message contains the reference number (not shown) of the Assistance Data originally received in step S202.

Calculating location in an AGPS System. FIG. 4 illustrates the steps of obtaining compressed data from one base station 150 with SMLC 120. At step S400, the SMLC's 120 Reference Receiver 110 monitors visible satellites 130 i.e. N1, N2 and A1, A2 of FIG. 1. At step S402 SMLC 120 receives ephemeris and timing information of the satellites 130 and records data in real time at the SMLC 120 reference receiver 110. At step S404 the SMLC 120 uses the real time data collected from the satellites 130 and using components of the SMLC 120 such as, for example, reference receiver 110 and Position Calculation Function 160, compressed assistance data of the present invention is calculated. At step S406, a mobile device 140 requests GPS assistance data from the Base Station Centre (BSC) 150 so that the mobile device can calculate location B. At step S408, the SMLC 120 sends compressed assistance data of the present invention to the mobile device 140 so that the mobile device 140 can calculate its location B. Finally, at step S410 the SMLC 120 transmits the compressed assistance data to the mobile device 140, via base station 150.

The steps S400 through S410 illustrate an embodiment of steps that could happen with data from one base station. The mobile device 140 will need compressed data from between two and four base stations in order to calculate its position. Calculation could be performed as described herein, in conjunction with FIG. 2, and trilateration, or triangulation. It should be noted that the total time for a mobile device 140 to calculate its location based on the assistance data information is in turn reduced by using compressed assistance data. Furthermore, some of the steps described herein may happen substantially concurrently, as may be determined by one of ordinary skill in the art.

In one example use of the present invention, a real mobile device, such as mobile 140 of FIG. 1, uses compressed data from the method of the present invention to determine its location. The mobile device 140 interfaces with an Air Access WCDMA network in a box, commercially available from Spirent Communications. The Air Access network would receive a calculated fix (meaning the calculated location of the real mobile) from the real mobile.

AGPS SYSTEM can be emulated using a UMTS system commercially available from Spirent Communications. The UMTS system Location Test System (ULTS) is an integrated solution that enables comprehensive Assisted GPS (A-GPS) performance analysis of GSM/and WCDMA mobile devices in the lab, helping to reduce the time and cost of extensive field trials.

A Base Station Centre, can be emulated using a Base Station Emulator or GSM/WCDMA Base Station Emulator commercially available from Spirent Communications. The base station emulator could be used in the method to transmit the compressed data to the mobile device.

A Spirent SMLC Emulator could be used in place of the SMLC 120. This product is also commercially available from Spirent Communications. A Serving Mobile Location Centre (SMLC) emulator is used in emulation of an A-GPS network. The SMLC manages the processing associated with the location of a mobile and in many cases makes the actual calculation of a mobile's location. In an embodiment of the invention, this device may perform the calculation using compressed data of the present invention, as may be determined by one of ordinary skill in the art.

These specification, as well as other calculation methods as determined by one of ordinary skill in the art, can be used by one of ordinary skill in the art to calculate location of a mobile device.

Although various embodiments which incorporate the teachings of the present invention have been shown and described in detail herein, those skilled in the art can readily devise many other varied embodiments that still incorporate these teachings.

I claim:

1. A method of reducing total time for calculating a location of a mobile device using assisted global positioning system data from at least two satellites with similar information elements, the method comprising the steps of:
a) collecting a first element data set from a first satellite;
b) collecting a second element data set from a second satellite;
c) summing the element data set collected from the first satellite;
d) determining a third element data from the collected first element data and the collected second element data set by determining the difference between the collected first element data set and the collected second element data set;
e) summing element data of the third determined element data;
whereby the summed third determined element data is compressed assistance data that is used to determine a location of a mobile device.

2. The method as claimed in claim 1 whereby the first and second element data set from the first satellite is Almanac element data.

3. The method as claimed in claim 1 whereby the first and second element data set from the first satellite is Navigation Model element data.

4. The method as claimed in claim 1 whereby the location of a mobile device is determined using the summed third determined element data and a triangulation calculation.
